(19) United States
(12) Patent Application Publication
(10) Pub. No.: US 2024/0046249 A1
(43) Pub. Date: Feb. 8, 2024

(54) METHODS AND SYSTEMS FOR LINKING DIGITAL WALLETS ON A BLOCKCHAIN NETWORK

(71) Applicant: WENEW, Inc., Los Angeles, CA (US)

(72) Inventors: Randy Chia-Wei Chung, Bellevue, WA (US); Jonathan Wang, Saratoga, CA (US); Michael De Leon Figge, Los Angeles, CA (US)

(21) Appl. No.: 17/816,923

(22) Filed: Aug. 2, 2022

(51) Int. Cl. G06Q 20/36; G06Q 20/38

(52) U.S. Cl. CPC G06Q 20/36; G06Q 20/3829; G06Q 20/389

(57) ABSTRACT

A technique is directed to methods and systems for linking digital wallets on a blockchain network. The linked digital wallet system can include a user interface that is used to manage tokens. A user can store tokens, private keys, public keys, or any information in a digital wallet. A digital wallet can refer to a hot wallet and/or a cold wallet. A hot wallet is connected to the internet. To prevent a cold wallet from connecting to the internet for a transaction, a user can link a cold wallet to a hot wallet. The hot wallet can perform a transaction on behalf of the linked cold wallet. For example, a user signs a transaction with the private key of the cold wallet, but the transaction address is the address of the hot wallet.

### BACKGROUND

Blockchain technology is used to transfer assets using tokens generated as part of a blockchain encryption process. An asset (e.g., an electronic coin, a blockchain-based good, a personal identifier, and so on) is represented by a chain of transactions that transfers ownership from one party to another party. To transfer ownership of an asset on a blockchain, a new transaction is generated and added to a stack of transactions in a block. The new transaction, which includes the public key of the new owner, is digitally signed by the owner with the owner's private key to transfer ownership to the new owner as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the asset. The blockchain creates a mathematical proof of ownership in an entity represented by a security identity (e.g., a public key), which can be pseudo-anonymous.

The blockchain technology can maintain a distributed ledger of transactions. With a distributed ledger, a ledger of all the transactions for an asset is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The blockchain system also implements techniques to ensure that each node will store the identical blockchain, even though nodes can receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The blockchain system also implements techniques to ensure that it would be infeasible to change a transaction and regenerate the blockchain by employing a computationally expensive technique to generate a nonce that is added to the block when it is created. A blockchain ledger is sometimes referred to as an Unspent Transaction Output (“UXTO”) set because it tracks the output of all transactions that have not yet been spent.

### BRIEF DESCRIPTION OF THE DRAWINGS

FIG. 1 illustrates a digital wallet system for linking digital wallets, in accordance with one or more embodiments of the present technology.

FIG. 2A is a flow diagram illustrating an example process of linking digital wallets, in accordance with an embodiment of the present technology

FIG. 2B is a flow diagram illustrating an example process of a transaction with linked digital wallets, in accordance with an embodiment of the present technology.

FIG. 3 is a block diagram illustrating an overview of devices on which some implementations can operate.

FIG. 4 is a block diagram illustrating an overview of an environment in which some implementations can operate.

FIG. 5 is a block diagram illustrating components which in some implementations can be used in a system employing the disclosed technology.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for linking digital wallets on a blockchain network. The linked digital wallet system can include a user interface that is used to manage tokens (e.g., Non-Fungible tokens (NFTs)), assets associated with distributed ledger smart contracts, digital wallets, access token-based marketplaces, etc. NFTs are cryptographic, distributed ledger smart contracts and may be associated with digital art, in some cases with specific digital art as part of the token. Contrary to fungible tokens, each non-fungible token is unique. Generally, NFTs are often associated with the ownership of digital art. At least some embodiments are directed to assets (e.g., tangible and/or intangible assets) and services associated with the assets of the NFT and processes for creation and consumption of those assets. The assets can be artwork, such as digital artwork, stenciling, etc. An NFT is created (or “minted”) by interacting with a smart contract on the blockchain. The minting process may include at least the functions designated by the ERC-721 or ERC-1155 standards.

A user can store an NFT(s), private keys, public keys, or any information in a digital wallet. A digital wallet can refer to a hot wallet and/or a cold wallet. A hot wallet is a digital wallet that is connected (e.g., continually connected) to the internet. For example, when a user creates an account on a cryptocurrency exchange (e.g., downloads an application on a device) the user has a hot wallet for their account to make transactions on the blockchain network. Cold wallets (e.g., hardware or paper wallets) are generally not connected to the internet and only connect for the length of time to complete transaction. Cold wallets are generally more secure than hot wallets because cold wallets are less susceptible to cyberattacks as cold wallets have less time connected to the internet than hot wallets. To prevent a cold wallet from having to the internet for a transaction, a user can link a cold wallet to a hot wallet. The hot wallet can perform a transaction on behalf of the linked cold wallet to protect the assets (e.g., private keys, public keys, etc.) stored in the cold wallet. For example, a user signs a transaction with the private key of the cold wallet, but the transaction address is the address of the hot wallet. In some embodiments, the user interface used to access the hot or cold wallets is a key based interface that links one or more cold wallets to a hot wallet. The link between a cold wallet and a hot wallet can expire after a time threshold. The owner of the cold wallet can lock the linked hot wallet to prevent other cold wallets from linking to the hot wallet.

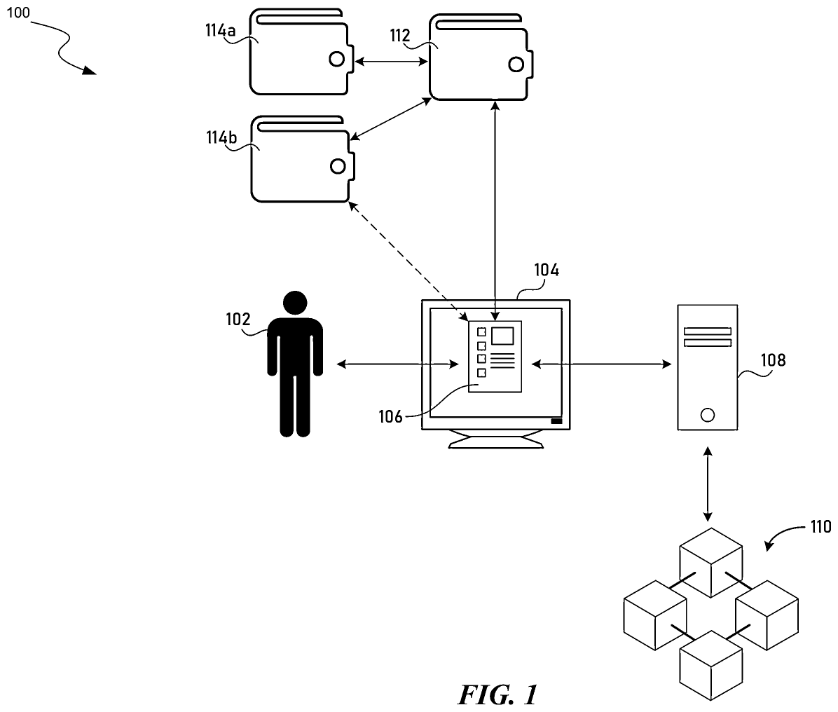

Several implementations are discussed below in more detail in reference to the figures. FIG. 1 illustrates a digital wallet system 100 for linking digital wallets, in accordance with one or more embodiments of the present technology. User 102 via user interface 106 on device 104 (e.g., a smartphone, a personal computing device, etc.) can connect to server 108 to access the blockchain 110. User interface 106 can have buttons, filters, windows, tools (e.g., image editing tools, digital wallet tools, ledger tools, etc.) to manage operations. For example, the user interface 106 includes a digital marketplace interface configured to allow user 102 to purchase and manage tokens, such as NFTs. The user interface 106 can include blockchain information, a list of rights associated with smart contracts, token information, etc. User 102 can use the user interface 106 to manage tokens, assets associated with distributed ledger smart contracts, digital wallets (e.g., hot wallet 112, cold wallet 114a, and/or cold wallet 114b), etc. For example, user 102 can purchase an NFT through the digital marketplace on the user interface 106. Upon purchase of the NFT, the user interface 106 submits the information to a server 108. The server 108 can initiate function calls to the NFT smart contract on the blockchain 110 to transfer the NFT to the buyer's wallet (e.g., hot wallet 112, cold wallet 114a, and/or cold wallet 114b), in exchange of a payment (e.g., blockchain payment, such as crypto currency).

In some implementations, multiple cold wallets (e.g., cold wallets 114a and 114b) are linked to a single hot wallet (e.g., hot wallet 112). User 102 can link cold wallets 114a and 114b to hot wallet 112 via the interface 106. The link between cold wallet 114a or 114b and hot wallet 112 can automatically expire after a time threshold (e.g., any time amount, such as a minute, hour, day, week, etc.). The link time threshold can be a user specified amount or a predetermined amount. In some implementations, the time threshold of the link is based on a risk tolerance of the transaction between the cold wallet 114a/114b and hot wallet 112. For example, if a transaction is above a monetary threshold, the link is active for a shorter time than if the transaction was below the monetary threshold. Interface 106 can display the time remaining that the link is active and/or send a notification (e.g., message, SMS, email, etc.) to user 102 when the link will expire within a time period. In some cases, each hot wallet can only be simultaneously linked to threshold number cold wallets and must remove a currently linked cold wallet to connect to a new cold wallet.

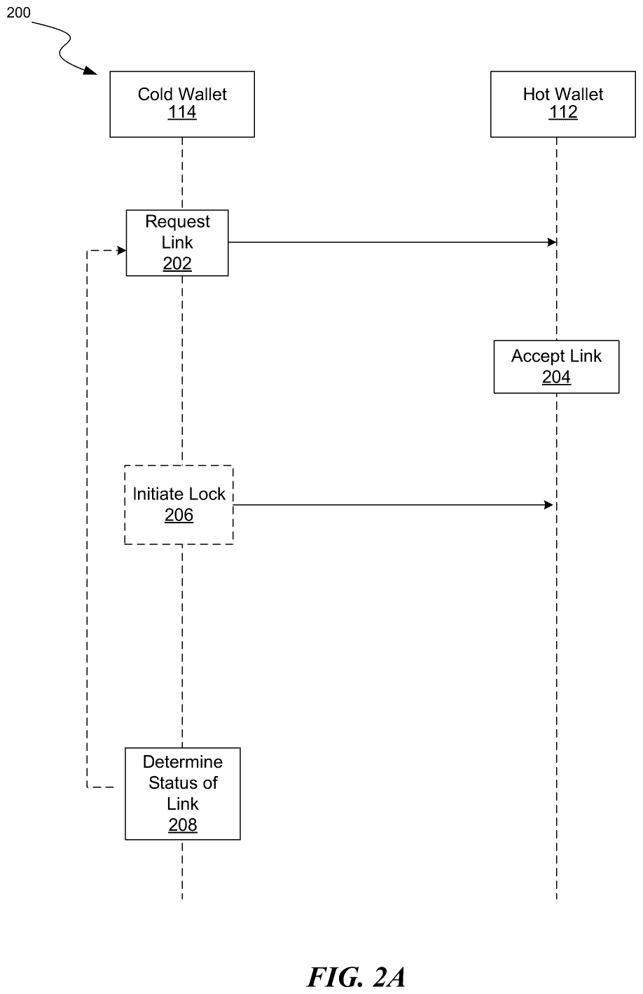

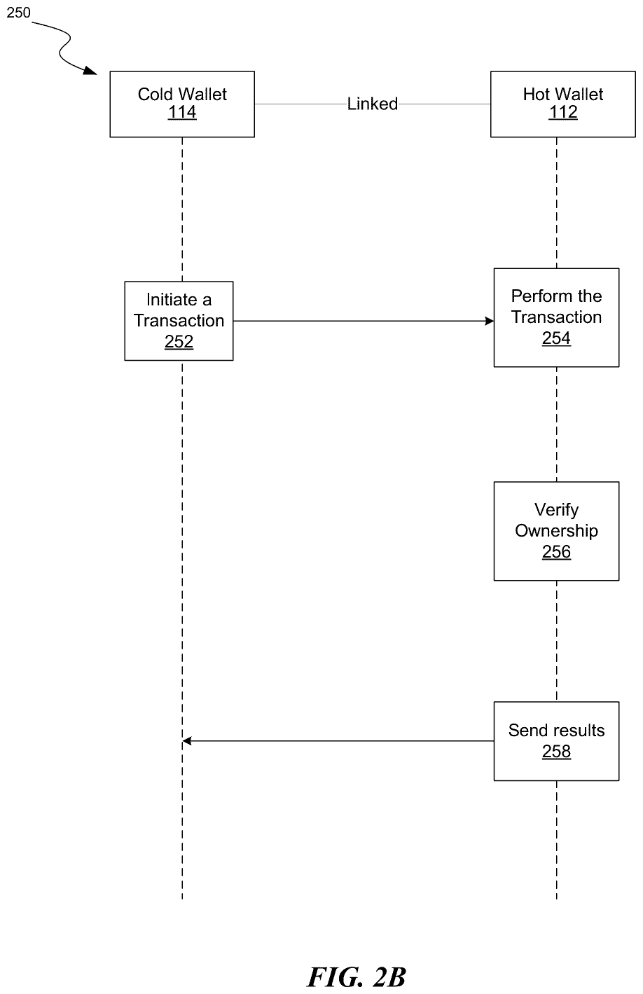

FIG. 2A is a flow diagram illustrating an example process 200 of linking digital wallets, in accordance with an embodiment of the present technology. Cold wallet 114 and hot wallet 112 can store tokens according to ERC-721 or ERC-1155 standards.

At block 202, cold wallet 114 requests a link to hot wallet 112. Process 200 can determine whether the hot wallet 112 is available to link with a cold wallet. For example, if the hot wallet 112 is currently connected to a threshold number of cold wallets, process 200 will deny the link request. If the hot wallet 112 is available to link with cold wallet 114, at block 204, hot wallet 112 accepts the link request from cold wallet 114. In some cases, hot wallet 112 is linked to multiple cold wallets simultaneously. Hot wallet 112 can unlink from cold wallet 114 an any time. Linking cold wallet 114 to hot wallet 112 allows the owner of hot wallet 112 to appear during the transaction as the owner (e.g., proxy owner) of cold wallet 114. In some cases, a cold wallet may not request a link to a hot wallet and would instead be immediately linked via an action from the cold wallet 114. In some implementations, a cold wallet can specify the hot wallet address that the cold wallet wants to link to. The hot wallet of the address can use the contract to look up which cold wallets are trying to link to the hot wallet and approve/deny each cold wallet link request. The link between a hot wallet and a cold wallet is stored in the contract data on the blockchain network.

At block 206, cold wallet 114 initiates a lock on hot wallet 112. While locked, hot wallet 112 is unable to connect to any other cold wallets. However, hot wallet 112 can unlock or lock itself at any time. In some implementations, cold wallet 114 requesting the link to hot wallet 112 triggers the lock of hot wallet 112. For example, to lock a hot wallet, a cold wallet can specify/request the hot wallet should be locked at the time of linking. A cold wallet requesting a lock on a hot wallet can cause the lock or the lock is not finalized until the hot wallet accepts the lock. To determine whether a hot wallet is locked, the hot wallet can analyze the contract data, or monitor the blockchain event log to identify if any lock events involving the hot wallet have occurred.

At block 208, cold wallet 114 determines the status of the link to hot wallet 112. Cold wallet 114 can determine the time remaining before the link expires or if the link has expired. If the link has expired, cold wallet 114 can request another link (return to block 202). In some implementations, the link between cold wallet 114 and hot wallet 112 ends at the completion of a transaction.

FIG. 2B is a flow diagram illustrating an example process 250 of a transaction with linked digital wallets, in accordance with an embodiment of the present technology.

At block 252, cold wallet 114 initiates a transaction on the blockchain network. At block 254, hot wallet 112 performs the transaction while linked to the cold wallet 114. The owner of the cold wallet 114 signs the transaction with the private key of the cold wallet 114 while the transaction address is the address of the hot wallet 112. The hot wallet 112 acts as the proxy owner of the transaction and identifies the cold wallet 114.

At block 256 hot wallet 112 verifies the ownership of assets of the cold wallet 112. For example, the smart contract associated with the transaction will report tokens (e.g., ERC721 and ERC1155 tokens) owned by the cold wallet 114 as being owned by the hot wallet 112. Verification of ownership can depend on what contract/token standards (e.g., ERC-721 or ERC-1155 standards) the proxy contract supports. Each contracts have specific methods that are used to determine ownership. The proxy contract can call these functions to determine ownership, using the union of the linked cold wallets and hot wallets. In some implementations, verifying ownership does not require any new blocks to be minted on the blockchain network, as verifying ownership can occur within the context of a single transaction. For example, when hot wallet 112 requests to mint an NFT, the NFT contract communicates with the wallet proxy and verifies ownership of a token that grants the permission to mint the NFT. Upon verifying valid ownership, process 250 mints an NFT to hot wallet 112. At block 258, hot wallet 112 sends the results (e.g., NFT information) of the transaction to cold wallet 114.

In an example of process 200 and 250, a cold wallet 114 links to a hot wallet 112. The hot wallet 112 calls the mint( ) function on the NFT contract FooBearsTwo, which is releasing a new NFT to all holders of FooBearsOne. FooBearsTwo calls the ownerOf( ) method on the WalletProxy contract, passing in the address of the hot wallet 112 and the address of contract FooBearsOne to validate the wallet currently owns a FooBearsOne. WalletProxy contract looks up all the cold wallets linked to the hot wallet 112 and identifies cold wallet 114. WalletProxy talks to FooBearsOne and checks ownerOf( ) for hot wallet 112, and cold wallet 114, and if either of the wallets own a FooBearsOne, then WalletProxy returns a positive ownership check to FooBearsTwo.

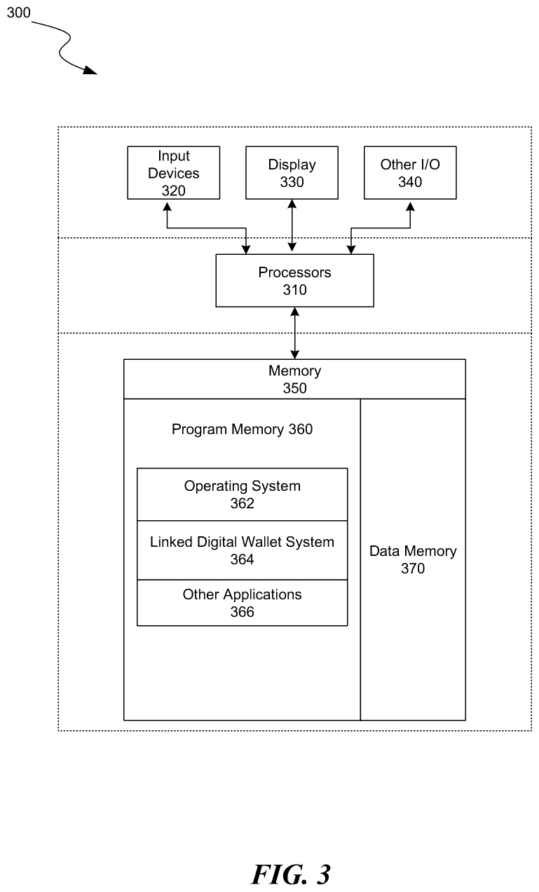

FIG. 3 is a block diagram illustrating an overview of devices on which some implementations of the disclosed technology can operate. The devices can comprise hardware components of a device 300 that manage entitlements within a real-time telemetry system. Device 300 can include one or more input devices 320 that provide input to the processor(s) 310 (e.g., CPU(s), GPU(s), HPU(s), etc.), notifying it of actions. The actions can be mediated by a hardware controller that interprets the signals received from the input device and communicates the information to the processors 310 using a communication protocol. Input devices 320 include, for example, a mouse, a keyboard, a touchscreen, an infrared sensor, a touchpad, a wearable input device, a camera- or image-based input device, a microphone, or other user input devices.

Processors 310 can be a single processing unit or multiple processing units in a device or distributed across multiple devices. Processors 310 can be coupled to other hardware devices, for example, with the use of a bus, such as a PCI bus or SCSI bus. The processors 310 can communicate with a hardware controller for devices, such as for a display 330. Display 330 can be used to display text and graphics. In some implementations, display 330 provides graphical and textual visual feedback to a user. In some implementations, display 330 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 340 can also be coupled to the processor, such as a network card, video card, audio card, USB, firewire or other external device, camera, printer, speakers, CD-ROM drive, DVD drive, disk drive, or Blu-Ray device.

In some implementations, the device 300 also includes a communication device capable of communicating wirelessly or wire-based with a network node. The communication device can communicate with another device or a server through a network using, for example, TCP/IP protocols. Device 300 can utilize the communication device to distribute operations across multiple network devices.

The processors 310 can have access to a memory 350 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 350 can include program memory 360 that stores programs and software, such as an operating system 362, linked digital wallet system 364, and other application programs 366. Memory 350 can also include data memory 370, storing throttle data, user data, machine data, transmission data, sensor data, device data retrieval data, management data, customer information data, configuration data, settings, user options or preferences, etc., which can be provided to the program memory 360 or any element of the device 300.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

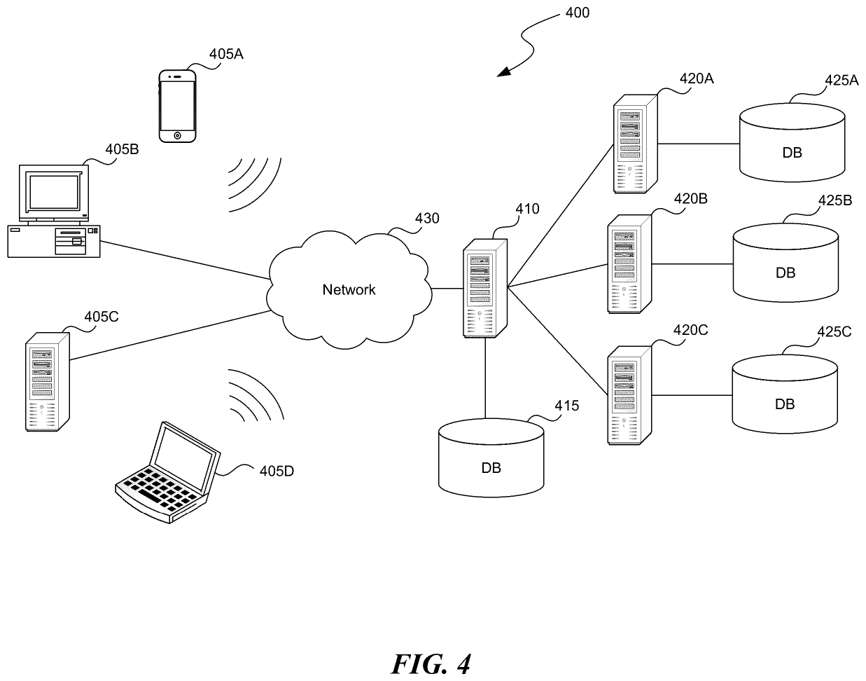

FIG. 4 is a block diagram illustrating an overview of an environment 400 in which some implementations of the disclosed technology can operate. Environment 400 can include one or more client computing devices 405A-D, examples of which can include device 300. Client computing devices 405 can operate in a networked environment using logical connections through network 430 to one or more remote computers, such as a server computing device 410.

In some implementations, server 410 can be an edge server which receives client requests and coordinates fulfillment of those requests through other servers, such as servers 420A-C. Server computing devices 410 and 420 can comprise computing systems, such as device 300. Though each server computing device 410 and 420 is displayed logically as a single server, server computing devices can each be a distributed computing environment encompassing multiple computing devices located at the same or at geographically disparate physical locations. In some implementations, each server 420 corresponds to a group of servers.

Client computing devices 405 and server computing devices 410 and 420 can each act as a server or client to other server/client devices. Server 410 can connect to a database 415. Servers 420A-C can each connect to a corresponding database 425A-C. As discussed above, each server 420 can correspond to a group of servers, and each of these servers can share a database or can have their own database. Databases 415 and 425 can warehouse (e.g. store) information such as implement data, machine data, sensor data, device data, notification data, measurement, and alert data. Though databases 415 and 425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN), but can also be other wired or wireless networks. Network 430 may be the Internet or some other public or private network. Client computing devices 405 can be connected to network 430 through a network interface, such as by wired or wireless communication. While the connections between server 410 and servers 420 are shown as separate connections, these connections can be any kind of local, wide area, wired, or wireless network, including network 430 or a separate public or private network.

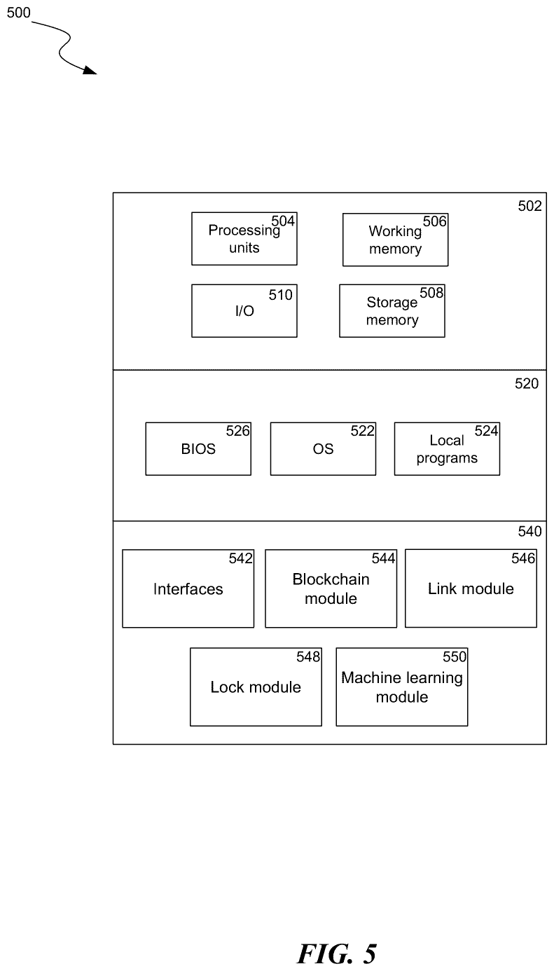

FIG. 5 is a block diagram illustrating components 500 which, in some implementations, can be used in a system employing the disclosed technology. The components 500 include hardware 502, general software 520, and specialized components 540. As discussed above, a system implementing the disclosed technology can use various hardware including processing units 504 (e.g. CPUs, GPUs, APUs, etc.), working memory 506, storage memory 508 (local storage or as an interface to remote storage, such as storage 415 or 425), and input and output devices 510. In various implementations, storage memory 508 can be one or more of: local devices, interfaces to remote storage devices, or combinations thereof. For example, storage memory 508 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 415 or storage provided through another server 420). Generally, memory 508 can include any device, mechanism, or populated data structure used for storing information. In accordance with some embodiments of the present disclosures, memory 508 can encompass, but is not limited to, any type of volatile memory, nonvolatile memory, and dynamic memory. For example, memory 508 can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory 508 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 508. In some example aspects, memory 508 may store at least one database containing network information (e.g., ledgers, private/public keys, etc.). Components 500 can be implemented in a client computing device such as client computing devices 405 or on a server computing device, such as server computing device 410 or 420.

General software 520 can include various applications including an operating system 522, local programs 524, and a basic input output system (BIOS) 526. Specialized components 540 can be subcomponents of a general software application 520, such as local programs 524. Specialized components 540 can include blockchain module 544, link module 546, lock module 548, machine learning module 550, and components which can be used for providing user interfaces (e.g., user interface 106), transferring data, and controlling the specialized components, such as interfaces 542. In some implementations, components 500 can be in a computing system that is distributed across multiple computing devices or can be an interface to a server-based application executing one or more of specialized components 540. Although depicted as separate components, specialized components 540 may be logical or other nonphysical differentiations of functions and/or may be submodules or code-blocks of one or more applications.

In some embodiments, the blockchain module 544 is configured to provide blockchain functionality for the system. The blockchain module 544 allows for the creation of a new block for a new/existing blockchain distributed ledger, hashing of the new block, and addition of the new block to the user's private blockchain and distributed ledger. Examples of hash functions include different types of Secure Hash Algorithms (SHA-1, SHA-2, or SHA-3) or a Jenkins hash function. The blockchain module 544 can manage a plurality of public blockchains, private blockchains, and/or other distributed ledgers for users. In some implementations, the privacy of each user's blockchain(s) can be ensured because each user maintains an individual blockchain and/or ledger for the user's data. In other implementations, transactions include a public key that matches a private key associated with the user. In these implementations, while the transactions are added to a public ledger, details of the transactions can only be accessed when the private key is used, ensuring user data privacy.

Blockchain module 544 is further configured to add new blocks to the blockchain when a user connects a device to the network or subscribes to the linked digital wallet service. For instance, if a user links a cold wallet to a hot wallet for a transaction, the transaction may be recorded on a blockchain so other nodes participating in the linked digital wallet system can successfully and accurately validate the user's transaction.

In some embodiments, the link module 546 is configured to link one or more cold wallets to a hot wallet. The link between a cold wallet(s) and a hot wallet can automatically expire after a time threshold (e.g., any time amount, such as a minute, hour, day, week, etc.). The link time threshold can be a user specified amount or a predetermined amount. In some implementations, the time threshold of the link is based on a risk tolerance of the transaction between the cold wallet and hot wallet 112. For example, if a transaction is above a monetary threshold, the link is active for a shorter time than if the transaction was below the monetary threshold. In some embodiments, the lock module 548 is configured to lock a hot wallet. While locked, a hot wallet is unable to connect to any other cold wallets. In some implementations, a cold wallet requesting the link to a hot wallet triggers the lock of the hot wallet.

In some embodiments, the machine learning module 550 is configured to link a cold wallet to a hot wallet based on a transaction. The machine learning module 550 may be configured to link a hot wallet to a cold wallet based on at least one machine-learning algorithm trained on at least one dataset of identified information of linking cold wallets to a hot wallet for transactions. The at least one machine-learning algorithms (and models) may be stored locally at databases and/or externally at databases. User devices may be equipped to access these machine learning algorithms and intelligently identify when to link a cold wallet to a hot wallet for a transaction based on at least one machine-learning model that is trained on a dataset of identified digital wallet linked transactions. As described herein, a machine-learning (ML) model may refer to a predictive or statistical utility or program that may be used to determine a probability distribution over one or more-character sequences, classes, objects, result sets or events, and/or to predict a response value from one or more predictors. A model may be based on, or incorporate, one or more rule sets, machine learning, a neural network, or the like. In examples, the ML models may be located on the client device, service device, a network appliance (e.g., a firewall, a router, etc.), or some combination thereof. The ML models may process user information databases and other data stores to determine how and when to link a cold wallet to a hot wallet for a transaction.

Based on the linked digital wallet information from user information databases and platforms and other user data stores, at least one ML model may be trained and subsequently deployed to automatically link a cold wallet to a hot wallet for a transaction. The trained ML model may be deployed to one or more devices. As a specific example, an instance of a trained ML model may be deployed to a server device and to a client device which communicate with a machine. The ML model deployed to a server device may be configured to be used by the client device when, for example, the client device is connected to the Internet. Conversely, the ML model deployed to a client device may be configured to be used by the client device when, for example, the client device is not connected to the Internet. In some instances, a client device may not be connected to the Internet but still configured to receive satellite signals with item information, such as specific NFT information. In such examples, the ML model may be locally cached by the client device.

### CONCLUSION

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A computing system comprising:
at least one processor; and
at least one memory storing instructions that, when executed by the at least one processor, cause the computing system to perform a process for linking one or more digital wallets, the process comprising:
linking a first digital wallet to a second digital wallet for a time threshold;
initiating, by the first digital wallet, a transaction to occur from the second digital wallet, wherein the second digital wallet is a proxy owner of the first digital wallet for the transaction;
signing the transaction with a private key of the first digital wallet and an address of the second digital wallet; and
in response to signing the transaction, unlinking the first digital wallet from the second digital wallet.

2. The computing system of claim 1, wherein the process further comprises:
in response to linking the first digital wallet to the second digital wallet, locking the second digital wallet from connecting to other digital wallets.

3. The computing system of claim 1, wherein the process further comprises:
determining a number of links between the second digital wallet and other digital wallets; and
in response to the number of links exceeding a threshold, declining a request from a third digital wallet to link with the second digital wallet.

4. The computing system of claim 1, wherein the process further comprises:
unlinking the first digital wallet from the first digital wallet after the time threshold is met.

5. The computing system of claim 1, wherein the process further comprises:
linking two or more digital wallets simultaneously to the second digital wallet.

6. The computing system of claim 1, wherein the process further comprises:
verifying, by the second digital wallet, an owner of the first digital wallet.

7. The computing system of claim 1, wherein the first digital wallet is a cold wallet on a blockchain network and the second digital wallet is a hot wallet on the blockchain network, and wherein the transaction includes an NFT governed by a smart contract.

8. A method for linking one or more digital wallets, the method comprising:
linking a first digital wallet to a second digital wallet for a time threshold;
initiating, by the first digital wallet, a transaction to occur from the second digital wallet, wherein the second digital wallet is a proxy owner of the first digital wallet for the transaction;
signing the transaction with a private key of the first digital wallet and an address of the second digital wallet; and
in response to signing the transaction, unlinking the first digital wallet from the second digital wallet.

9. The method of claim 8, further comprising:
in response to linking the first digital wallet to the second digital wallet, locking the second digital wallet from connecting to other digital wallets.

10. The method of claim 8, further comprising:
determining a number of links between the second digital wallet and other digital wallets; and
in response to the number of links exceeding a threshold, declining a request from a third digital wallet to link with the second digital wallet.

11. The method of claim 8, further comprising:
unlinking the first digital wallet from the first digital wallet after the time threshold is met.

12. The method of claim 8, further comprising:
linking two or more digital wallets simultaneously to the second digital wallet.

13. The method of claim 8, further comprising:
verifying, by the second digital wallet, an owner of the first digital wallet.

14. The method of claim 8, wherein the first digital wallet is a cold wallet on a blockchain network and the second digital wallet is a hot wallet on the blockchain network, and wherein the transaction includes an NFT governed by a smart contract.

15. A non-transitory computer-readable storage medium comprising: a set of instructions that, when executed by at least one processor, causes the at least one processor to perform operations for linking one or more digital wallets, the operations comprising:
linking a first digital wallet to a second digital wallet for a time threshold;
initiating, by the first digital wallet, a transaction to occur from the second digital wallet, wherein the second digital wallet is a proxy owner of the first digital wallet for the transaction;
signing the transaction with a private key of the first digital wallet and an address of the second digital wallet; and
in response to signing the transaction, unlinking the first digital wallet from the second digital wallet.

16. The non-transitory computer-readable storage medium of claim 15, wherein the operations further comprise:
in response to linking the first digital wallet to the second digital wallet, locking the second digital wallet from connecting to other digital wallets.

17. The non-transitory computer-readable storage medium of claim 15, wherein the operations further comprise:
determining a number of links between the second digital wallet and other digital wallets; and
in response to the number of links exceeding a threshold, declining a request from a third digital wallet to link with the second digital wallet.

18. The non-transitory computer-readable storage medium of claim 15, wherein the operations further comprise:
unlinking the first digital wallet from the first digital wallet after the time threshold is met; and
verifying, by the second digital wallet, an owner of the first digital wallet.

19. The non-transitory computer-readable storage medium of claim 15, wherein the operations further comprise:
linking two or more digital wallets simultaneously to the second digital wallet.

20. The non-transitory computer-readable storage medium of claim 15, wherein the first digital wallet is a cold wallet on a blockchain network and the second digital wallet is a hot wallet on the blockchain network, and wherein the transaction includes an NFT governed by a smart contract.
